(19) United States
(12) Patent Application Publication
(10) Pub. No.: US 2020/0111379 A1
(43) Pub. Date: Apr. 9, 2020

(54) MITIGATING VARIANCE IN STANDARDIZED TEST ADMINISTRATION USING MACHINE LEARNING

(71) Applicant: ACT, INC., Iowa City, IA (US)

(72) Inventor: Zhongmin Cui, Iowa City, IA (US)

(21) Appl. No.: 16/254,347

(22) Filed: Jan. 22, 2019

Related U.S. Application Data
(63) Continuation-in-part of application No. 16/151,295, filed on Oct. 3, 2018.

(51) Int. Cl. G09B 7/06; G06N 20/20; G06Q 50/20

(52) U.S. Cl. CPC G09B 7/06; G06Q 50/205; G06N 20/20

(57) ABSTRACT

A method for mitigating variability in standardized examination administration includes obtaining testing conditions associated with the administration of standardized examinations, obtaining indications that testing conditions from the first set of testing conditions are irregular, training a machine learning-based irregularity determination model based on the indications and corresponding testing conditions, displaying the identified irregular testing conditions on a user interface, and verifying the accuracy of the irregularity determination model.

### CROSS REFERENCE

This application is a continuation-in-part of and claims priority to U.S. patent application Ser. No. 16/151,295, titled “Digitized Test Management Center,” filed on Oct. 3, 2018, the contents of which are incorporated herein in their entirety.

### TECHNICAL FIELD

The disclosed technology relates generally to standardized testing. More particularly, various embodiments relate to systems and methods for mitigating variance in standardized test administration using machine learning.

### BACKGROUND

Academic performance and professional qualifications may be evaluated using standardized examinations. The subject matter encompassed in these standardized examinations may span multiple academic disciplines and professions. To efficiently administer standardized examinations over multiple geographic, while minimizing the opportunity for both intra-site and inter-site cross-contamination of examination solutions between students, these standardized examinations are generally administered contemporaneously or near-contemporaneously across multiple testing locations and geographies. Thus, many examinees may take a particular standardized exam at different testing sites at the same time. Standardized examinations are generally “proctored” to minimize and report irregularities that may affect the normalization of standardized results for a given examination. For example, irregularities may include events such as power outages, unexpected noises (bells, alarms, sirens, etc.), emergencies (e.g., earthquakes, fires, etc.), irregularities in environmental conditions (e.g., too hot, air conditioner not working, too cold, heater not working, etc.), disruptive examinees, inconsistencies with examinee rosters or seating charts, irregular examinee behaviors, or other deviations from normal test taking environments. Such irregularities may affect examination scores, and in some cases, may be accounted for to assist in normalization of standardized scores. However, current test administration systems generally require manual tracking of irregularities, and do not account for irregularity tracking across multiple test taking sites and geographies, thus limiting the amount of useful irregularity data that can be used to understand and normalize standardized examination results, and detracting from examination credibility.

### BRIEF SUMMARY OF EMBODIMENTS

A method is disclosed for improving proctoring conditions using an examination administration system comprising a command center communicatively coupled to a plurality of testing sites. The method includes obtaining, with an input logical circuit, information pertaining to a first set of examinees and a second set of examinees and generating, with an analytics logical circuit, a first set of examinee-specific profiles for the first set of examinees and a second set of examinee-specific profiles for the second set of examinees, based on the obtained information. The input logical circuit, for example, may include a processor and a non-transitory computer readable medium with computer executable instructions embedded thereon. The computer executable instructions may cause a graphical user interface (GUI) to display a request for information to a user, e.g., by providing prompts, blanks, or menus for inputting information, and to store the acquired user input in a data store. The analytics logical circuit, for example, may include a processor and a non-transitory computer readable medium with computer executable instructions embedded thereon. The computer executable instructions may obtain the user input from the data store and apply a set of rules based on the user input as disclosed herein.

The method may include obtaining, from one of the testing sites, an examinee-specific authentication key for each examinee of the first set of examinees and the second set of examinees and displaying, through a first GUI on a first mobile device, a first set of proctoring instructions specific to the first set of examinees, wherein the first set of proctoring instructions is selected for administering examinations in a first location of the plurality of testing sites, based on the examinee profile of the first set of examinees. The method may also include displaying, through a second graphical user interface on a second mobile device, a second set of proctoring instructions specific to the second set of examinees, wherein the second set of proctoring instructions is selected for administering examinations in a second location of the plurality of testing sites based on the examinee profiles of the second set of examinees.

Some embodiments of the method include comparing, with the analytics logical circuit, the set of examinee-specific profiles to the examinee-specific authentication key for each examinee of the first set of examinees and the second set of examinees; monitoring, with the analytics logical circuit, global factors and local factors in the plurality of testing sites. In some examples, the authentication key may be a paper examination answer sheet or test booklet. In some examples, the authentication key may be an identification card, a username and password, a physical or digital token, a paper form, a biometric identification, or other types of keys and/or tokens. Example global factors may include external events impacting the testing conditions in the first testing site and the second testing site. Example local factors may include respective behaviors of each examinee in the first testing site and the second testing site. The method may include transmitting, by a communications logical circuit, the global factors and the local factors to a database in the testing command center (e.g., contemporaneously in real-time or asynchronously, e.g., at times when it is practical to transmit data based on connectivity considerations). The database may include preconfigured profiles associated with validated standardized testing conditions.

Some examples of the method include generating, with the analytics logical circuit, a testing environment index for the first testing site and second testing site, based on the global factors and generating, with the analytics logical circuit, a behavioral index for each examinee of the first set of examinees and the second set of examinees, based on the global factors and local factors.

In some embodiments, the method includes comparing, with the analytics logical circuit, the testing environment index and the behavioral index to the preconfigured profiles and identifying, with the analytics logical circuit, irregularities within the global and local events in real-time, based on findings obtained from comparing the testing environment index and the behavioral index to the preconfigured profiles; determining, by the analytics circuits, whether the irregularities necessitate corrective action by the command center. In some examples, if the irregularities necessitate corrective action based on a predetermined set of criteria, the method includes generating, by the analytics logical circuit, a pre-selected response to the irregularities in real-time and triggering at the first graphical user interface or the second graphical user interface, the pre-selected response to address the irregularities. The pre-selected response may be graphical and/or audible in nature.

The present disclosure also provides an examination administration system for improving proctoring conditions based on the method above. The system may include a command center communicatively coupled to a plurality of testing sites.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a data processing environment illustrating for supporting a digitized and interactive toolset when administering standardized examinations, in accordance with the embodiments disclosed herein.

FIG. 2 is a block diagram of a device for supporting a digitized and interactive toolset when administering standardized examinations, in accordance with embodiments disclosed herein.

FIG. 3 is a computing environment for registering examinees, in accordance with embodiments disclosed herein.

FIG. 4 is a flowchart of the functions performed for supporting a digitized and interactive toolset when proctoring standardized examinations, in accordance with embodiments disclosed herein.

FIG. 5A is an example of a user interface supported by the devices for supporting a digitized and interactive toolset when administering standardized examinations, in accordance with embodiments disclosed herein.

FIG. 5B is another example of a user interface supported by the device for supporting a digitized and interactive toolset when administering standardized examinations, in accordance with embodiments disclosed herein.

FIG. 6 is an illustration of local and global factors detectable by the device for supporting a digitized and interactive toolset when administering standardized examinations, in accordance with embodiments disclosed herein.

FIG. 7 is a depiction of a question and associated answer key on which irregularities are identified, in accordance with embodiments disclosed herein.

FIG. 8 is a depiction summarizing true positive, true negative, false positive, and false negative outcomes of applying the supervised learning steps for identifying irregularities, in accordance with embodiments disclosed herein.

FIG. 9 is a table summarizing irregularity reports, training sets, and training sets flagged for irregularities by the supervised learning steps, in accordance with embodiments disclosed herein.

FIG. 10A is a table summarizing instances identified as “okay” and “flagged” by the supervised learning steps and a human expert where the cutoff is 0.0, in accordance with embodiments disclosed herein.

FIG. 10B is a table summarizing instances identified as “okay” and “flagged” by the supervised learning steps and a human expert where the cutoff is −0.6, in accordance with embodiments disclosed herein.

FIG. 10C is a table summarizing instances identified as “okay” and “flagged” by the supervised learning steps and a human expert where the cutoff is −0.8, in accordance with embodiments disclosed herein.

FIG. 11 is an example of a computing system that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Complications in proctoring a standardized exam may be introduced by: instances where multiple examinees are taking the same exam in the same testing site; instances where multiple examinees are taking the same exam in the different testing sites; and instances where at least some of the multiple examinees are taking different exams in the same testing site. Additionally, different standardized examinations may require different proctoring instructions. This may lead to potential variability when administering standardized examinations. The standardized examinations may be digital or paper-based tests. In one example, some tests have a multiple-choice section and writing section, whereas other have either a multiple choice or writing section. In another example, calculators and rulers are permitted for some test and disallowed for others. Furthermore, disallowed calculators and rulers may be used as cheating devices. Sprinklers going off or pipes bursting at or near a testing site negatively impact the testing and proctoring experience.

Standardized examinations should be administered, proctored, and evaluated in a regimented, uniform, and objective manner to maintain the integrity and validity of test scores. Irregularities when administering, proctoring, or evaluating standardized examinations introduce undesired inconsistencies and variabilities that can negatively impact the integrity and validity of test scores. For example, examinee responses to an essay question are evaluated by graders A-D, based on a criterion developed by the standardized examination agency, wherein the criterion contains items 1, 2, and 3. Graders A, B, and C follow the criterion loosely, whereas grader D follows the criterion very strictly. More specifically, grader A evaluates responses on item 1 only; grader B evaluates responses on item 2 only; grader C evaluates responses on item 3 only; grader C evaluates responses on item 3; and grader D evaluates responses based on items 1, 2, and 3. Furthermore, examinee responses evaluated by graders A, B, and C score much higher than examinee responses evaluated by grader D. Thus, inconsistencies and variabilities in the evaluations of tests containing the essay question by graders A-D are indicative of irregularities that may adversely impact the integrity and validity of the test scores.

Irregularities should be addressed by screening for and identifying them in reports. In turn, the irregularities must be corrected for to remove the adverse impacts the integrity and validity of the test scores. Often, humans generate the reports that screen for and identify irregularities. This is a manual and time-consuming process marred with subjective judgements at times. As stated above, objectivity and uniformity help maintain the integrity and validity of scores. Thus, subjective judgements would not correct for the identified irregularities. The systems and methods disclosed can replace the current manual process saving time and money while providing objective judgments in an automated manner (i.e., removing the subjective nature of identifying and correcting for irregularities). More specifically, the systems and methods directed to machine learning techniques that: (i) analyze data sets associated with past decisions; (ii) train a computer system to make similar decisions; (iii) screen for irregularities based on the training of the computer system; (iv) pre-screen irregularity reports for human; and (v) continuously improve screening and pre-screening by analyzing added data sets and making more decisions.

In summary, the methods and systems, as described herein, leverage supervised learning for enhanced administration, proctoring, and evaluation during the standardized examination process. More specifically, the automation, as supported by supervised learning, may reduce or eliminate production costs; shipping expenses; data-entry, which is often tedious, manual, and prone to errors; and subjective evaluations.

In some examples the method may include implementing one or more applications in an IOS, Android, or web-based device, the one or more applications being communicatively coupled to an irregularity monitoring database. The application may be provided, for example, as a field resource (i.e., a proctor at a testing site) for administering and proctoring a live digital or paper-based test. The application may be used by the proctor for the following functions: (i) onboarding and renewing testing centers in a digital environment; (ii) managing distributed training for test center staff; (iii) compiling environmental data required for compliance with secure testing policies; (iv) timing administrative tasks and subject tests in accordance with standardized testing practices; (v) managing tasks associated with paper-assessment administration in a linear fashion; and/or (vi) digitally capturing and correcting irregularities associated with paper-assessment administration within an testing site and across testing sites. These functions may facilitate the transition from an industry standard paper-based administration tool set to a digital, interactive toolset. In turn, the extensibility, utility, and warranty of the administration of standardized examinations may be enhanced.

By leveraging digitization and high-speed inter-site and intra-site communications, and integrating a central command center production costs; shipping expenses; and data-entry may be reduced while consistency, accuracy, and conformity may be increased. These factors all promote a more reliable and accurate standardized testing result.

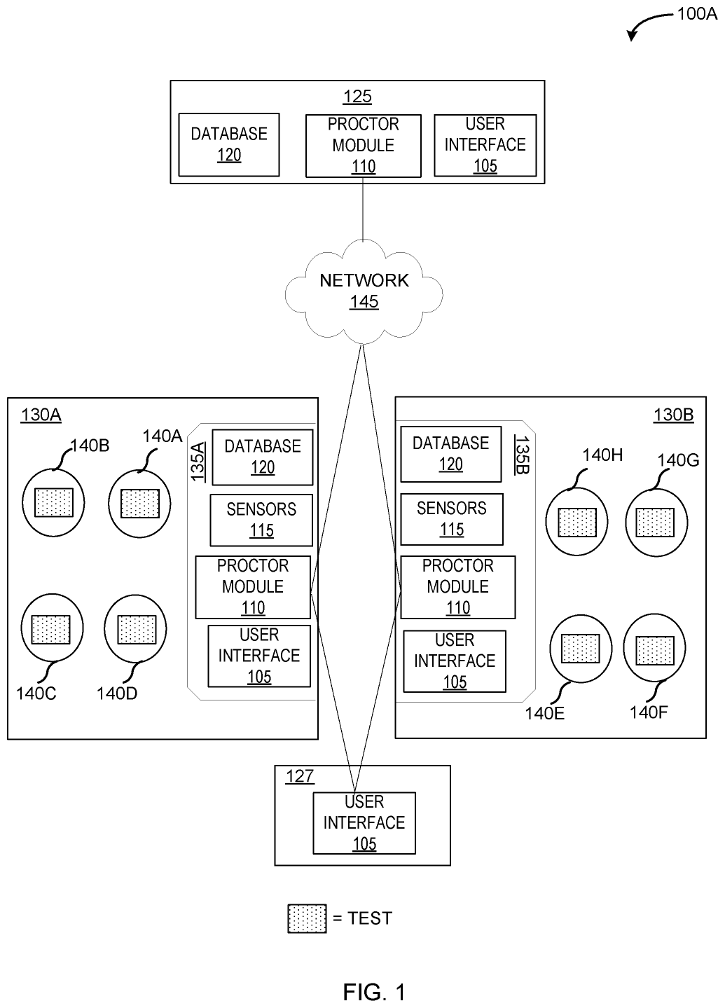

FIG. 1 is an example of a data processing environment for supporting a digitized and interactive toolset when administering standardized examinations. In some embodiments when administering standardized examinations, environment 100 includes command center 125, registration center 127, examination room 130A, and examination room 130B connected to each other via network 145.

Command center 125, registration center 127, device 135A, and device 135B are computing devices, such as a laptop computer, a tablet computer, a netbook computer, a personal computer (PC), a desktop computer, a personal digital assistant (PDA), a smart phone, or any programmable electronic device capable of communicating with each other via network 145. Device 135A and device 135B are in use by Proctor A and Proctor B, respectively. Additionally, device 135A and device 135B reside at testing sites 130A and 130B, respectively. Testing sites 130A and 130B may be in the same building within close proximity of each other or in different buildings not within close proximity. In an exemplary embodiment, desks 140A-D and desks 140E-G are contained in testing sites 130A and 130B, respectively. Examinees at testing site 130A are seated in desks 140A-D, whereas examinees at testing site 130B are seated in desks 140E-F. Registration center 127 resides in each building where a digital or paper-based test or any other type of standardized examination is being administered.

Device 135A and device 135B contain sensors 115, whereas command center 125 does not contain sensors 115. Sensors 115 detect gyroscopic shifts and oscillations that may be associated with testing conditions (e.g., an earthquake or seismic event), temperature, humidity, moisture levels, and images associated with moving and stationary objects. In turn, proctor module 110 works in combination with sensors 115 in device 135A and device 135B to construct edge computing systems and methods. The constructed edge computing optimizes application and cloud computing systems by reallocating some portion of information collection and management task from a core node of command center 125 to edge nodes of device 135A and device 135B. The edge nodes are in contact with the physical world, for example, the examinees and the conditions to which the examinees are exposed to. Additionally, the proximity of proctor modules 110 in device 135A and device 135B allow for real-time collection and analysis of proctoring conditions and examinee behavior at testing sites 130A and 130B, respectively. By collecting and analyzing proctoring conditions and examinee behavior in real-time, proctor module 110 reduces variability during the proctoring process; instantly alerts command center 125 of problematic testing triggers, such as a burst pipe or potential cheating; and devises a solution to remedy the problematic testing triggers.

Registration center 127 is controlled by proctor module 110 on device 135A and device 135B, which are in use by Proctors A and B, respectively. UI 105 in registration center 127 is invoked by proctor module 110 to obtain the registration information of each examinee. The registration information may include: name of the examinee, date of birth, social security number, encryption information sent to an examinee prior to date of test, passport information, driver license identification, and/or government issued identification. The registration information obtained at UI 105 in registration center 127 are sent to database 120 in device 130A, device 130B, and test command center 125 via the respective unit of proctor module 110. For example, a first unit of registration center 127 and testing site 130A reside in Building A and a second unit of registration center 127 and testing site 130B reside in Building B, wherein Building A and Building B are different buildings. In this example, proctor modules 110 in device 135A and device 135B are in use by Proctor A and Proctor B at testing site 130A and testing site 130B, respectively. In turn, proctor modules 110 in device 135A and device 135B manage the first unit of registration center 127 and the second unit of registration center 127, respectively.

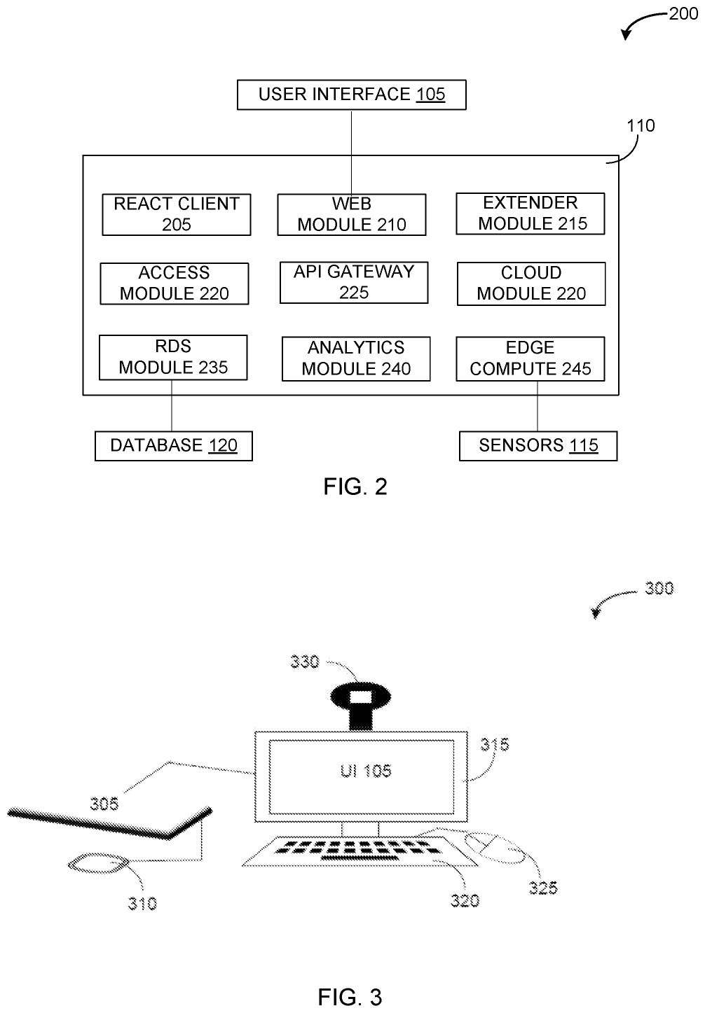

Command center 125 is connected to device 130A, device 130B, and registration center 127. Through proctor module 110, database 120 receives the registration information in real-time from the different units of registration center 127 at different testing sites. As a primary way of vetting the examinees, proctor module 110 invokes analytics module 240 (which is described in further detail with respect to FIG. 2) to compare the obtained information from registration center 127 to the profile information. If proctor module 110 finds any inconsistencies between the obtained information and the profile information, the inconsistencies are highlighted and outputted to user interface 105 in command center 125. For example, proctor module 110 within command center 125 notices the inconsistencies outputted to UI 105 of an examinee at Building A which contains testing site 130A. Proctor module 110 in command center 125 sends an encrypted message to proctor modules 110 in device 135A and 135B. However, the encrypted message can only be decrypted by proctor module 110 in device 135A, as the inconsistencies pertain only to testing site 130A at Building A.

Network 145 may be local area network (LAN); a wide area network (WAN), such as the Internet; the public switched telephone network (PSTN); a mobile data network; a private branch exchange (PDX); any combination thereof; or any combination of connections and protocols that support communications between the devices. Network 145 may include wired, wireless, or fiber optic connections.

User interface (UI) 105 is a graphical user interface (GUI) residing on a device, such as devices 130A and 130B or devices in command center 125 and registration center 127. UI 105 may also be connected to external devices, such as a computer keyboard or mouse. Graphical elements presented in UI 105 are controlled by proctor module 110. More specifically, proctor module 110 applies encryption technology, machine learning, and edge computing methods to control and modify the graphical elements in an UI 105 presented in a device, depending on the end-user. For example, the graphical elements outputted to U1 105 in device 135A or 135B, which is in use by a proctor, is different than the graphical elements outputted to UI 105 in registration center 127, which is in use by an examinee.

Database 120 is an organized collection of information that is stored and accessed electronically. A unit of database 120 resides in command center 125, device 135A, and device 135B. Proctor module 110 is able to communicate with database 120 to share the information using structured query language (SQL). Database 120 also contains the profile information of each examinee, such as date of birth; social security number; testing registration number; test registered for (e.g., subject test or general test); testing history that includes prior test scores and date of each test; and encryption information. On and after the test date, the profile information of each examinee is updated with obtained information from registration center 127 and the digitally captured behaviors of each examinee during the test. For example, database 120 is a relational extensible markup language (XML) databases amenable to SQL searches based on XML document attributes. The SQL searches are performed on information organized into one or more tables, or relations, of columns and rows, wherein each row is identified by a unique key. The rows are also referred to as records or tuples; and the columns are also referred to as attributes. For example, a first table contains profile information of each examinee; a second table contains the obtained information from registration center 127; a third table contains the information associated with the behaviors of the examinee; a fourth table contains information on each testing site; a fifth table contains information on ideal testing conditions; a sixth table contains information on non-ideal testing condition (e.g., pipes bursting, sprinklers going-off, an examinee experiencing an emergency situation, etc.); and a seventh table contains information on testing instructions to be provided by each proctor.

Proctor module 110 moves from a narrowly focused paper-based administrative protocol, to a digitally enabled solution by providing real-time data to command center 125. A unit of proctor module 110 resides in device 135A, device 135B, and command center 125. Command center 125 is operated by a centralized staff. Proctor module 110 may aid proctors by devising a decision-making practice that can take place during a live test event. Previously, paper-based administrative frameworks do not allow for real time insight or management. Materials are collected and returned to a central hub (e.g., command center 125) where data is retrieved. In turn, insights, for example, into paper-based administration protocols and testing events are gained only upon the conclusion of testing events. Non-disruptive digital communication tools, such as proctor module 110, are not currently used for paper-based administrations.

The advantages of proctor module 110 include: automation of the test administration workflow to eliminate administrator manuals; implementation of test administration training requirements and validation tools to improve the overall quality of test administration; development of a more robust knowledge of testing site conditions to be informed of security, cost containment, and efficacy initiatives; reduction or even elimination of intervention from test administration staff by moving the point of data entry into the test administration network; and devised communication solutions that create an active dialogue between the test administration network and ACT staff, in a simplified way; and seating charts with a depth of functionality that address materials linkage, irregularity reporting, intra-site mobility, and contribute to test security efforts. In an exemplary embodiment, proctor module 110 in device 135A outputs a first seating chart containing desks 140A-D to UI 105 in device 135A. In the same exemplary embodiment, proctor module 110 in device 135B outputs a second seating chart containing desks 140E-G to UI 105 in UI 105 in device 135B. Therefore, proctor module 110 delivers real business value to the standardized examination process by: (i) reducing the amount of paper from the test administration process, (ii) reducing expenditures for temporary contract labor; (iii) optimizing the amount of personnel required in a test administration network; and (iv) generating an evergreen technical survey of the test administration network to advance insights into a testing network.

Stated another way, fewer proctors are needed to effectively administer tests across different sites more uniformly, while obviating the need for manual data entry and other tedious tasks susceptible to human error. For example, there are in fact four absentee examinees at testing site 130A. Proctor A mistakenly indicates there are five absentee examinees at testing site 130A, while simultaneously performing other essential tasks, such as distributing test booklets and collecting answer sheets. Therefore, Proctor A can focus exclusively on essential tasks at testing site 130A, while proctor module 110 works with sensors 115 and database 120 to obtain and record information associated with tedious tasks at testing site 130A, such as noting when examinees enter and leave.

Proctor module 110 is a combination of different modules and logical circuits, which are described in more detail with respect to FIG. 2.

FIG. 2 is an example of a block diagram of a device for supporting a digitized and interactive toolset when administering standardized examinations. As described above, the logical circuits in proctor module 110 includes a processor and a non-volatile memory with computer executable instructions embedded thereon, as depicted in system 200. The computer executable instructions may be configured to cause the processor to perform the functions in the combination of logical circuits in proctor module 110. The combination of logical circuits in proctor module 110 includes: (i) mobile applications created in react client 205; (ii) model-view-controller (MVC) components for developing user interfaces, such as UI 105, through web module 210; (iii) a structural framework for dynamic web applications, such as extender module 215; (iv) security protocols and end-user access enforced by encryption methods, such as access module 220; (v) data structures, object classes, routines, variables, and/or remote calls defined and controlled by an application program interface (API), such as API Gateway 225; (vi) pools of computing resources which can be accessed, provisioned, and shared via cloud computing, as supported by cloud module 230; (vii) a stored procedure packaged as a unit to access and control a relational database service (RDS), such as database 120, through RDS module 235; (viii) data models generated by analytics module 240; and (ix) a module to support edge computing using sensors 115 through edge compute 245. This combination of logical circuits is configured to allow for data collection and machine learning techniques. In turn, proctor module 110 expedites and standardizes testing conditions across all testing sites for all examinees.

As used herein, the terms logical circuit and engine might describe a given unit of functionality that can be performed in accordance with one or more embodiments of the technology disclosed herein. As used herein, either a logical circuit or an engine might be implemented utilizing any form of hardware, software, or a combination thereof. For example, one or more processors, controllers, ASICs, PLAs, PALs, CPLDs, FPGAs, logical components, software routines or other mechanisms might be implemented to make up an engine. In implementations, the various engines described herein might be implemented as discrete engines or the functions and features described can be shared in part or in total among one or more engines. In other words, as would be apparent to one of ordinary skill in the art after reading this description, the various features and functionality described herein may be implemented in any given application and can be implemented in one or more separate or shared engines in various combinations and permutations. Even though various features or elements of functionality may be individually described or claimed as separate engines, one of ordinary skill in the art will understand that these features and functionality can be shared among one or more common software and hardware elements, and such description shall not require or imply that separate hardware or software components are used to implement such features or functionality.

In an embodiment, react client 205 is a combination of a JavaScript library and other libraries in proctor module 110 for building user interfaces (e.g., UI 105). This can be used as a base in the development of single-page or mobile applications. React client 205 in proctor module 110 is a logical circuit configured for state management, routing, and interaction with an API (e.g., API Gateway 225). State management refers to the state of one or more user interface (UI) controls such as text fields, OK buttons, radio buttons, etc. in a graphical user interface (GUI). In this UI programming technique, the state of one UI control depends on the state of other UI controls. For example, a state managed UI control, such as a button, will be in the enabled state when input fields have valid input values and the button will be in the disabled state when the input fields are empty or have invalid values. Routing refers to the mechanism where JavaScript frameworks interpret uniform resource locator (URL), which is colloquially termed a web address, for specifying the location of and retrieving a web resource on a computer network. Some features of the react client 205 include: passing properties to a component from the parent component as a single set of immutable values; holding state values throughout the component which can be passed to child components through the passed properties; creating in-memory data structure cache; updating the virtual document object model in a web browser; executing codes at set points during the component's lifetime via code that handles intercepted function calls, events, or messages (i.e., hooks); extending mirrored hypertext markup language (HTML) attributes; nesting elements of a code; and using conditional statements within JavaScript XML. The proctoring instructions from command center 125 are contained within the HTML attributes.

In an embodiment, web module 210 is a reusable solution presented as an architectural pattern in proctor module 110 for developing user interfaces (e.g. UI 105). More specifically, web module 210 is a logical circuit configured to divide applications, as created by react client 205 and API Gateway 225, into model-view-controller (MVC) components. The model is a dynamic data structure which manages data, logic, and rules of applications created by react client 205 and API Gateway 225. The view is any outputted representation of information sent to UI 105. The controller accepts inputs that are converted to commands for the model or view components. Some of the features of web module 210 into proctor module 110 include: allowing multiple developers to work simultaneously on the MVC components; logically grouping related actions together on a controller; logically grouping views for a specific model; loosely coupling MVC components; modifying MVC components; presenting multiple views of models; introducing new layers of abstraction within the coding structure of the MVC components; and scattering of multiple views.

In an embodiment, extender module 215 is a JavaScript-based front-end web application framework within proctor module 110. Extender module 215 is a logical circuit configured to extend code and make certain elements of code redundant. A plurality of individuals maintains react client 205 and API Gateway 225. As described above, react client 205 and API Gateway may create an HTML page containing embedded attributes. The embedded attributes are language constructs to bind input or output parts of the HTML page to a model represented by JavaScript variables. These variables refer to storage locations, which are identified by a memory address and paired with an associated symbolic name (an identifier). The identifier contains some known or unknown quantity of information referred to as a value. The separation of name and content of variables allows the name to be used independently of the exact information represented by the name. The identifier in computer source code can be bound to a value during run time. The value of the variable may also change during the course of program execution. In this embodiment, the HTML page is created by a plurality of individuals at command center 125, wherein the HTML page contains proctoring instructions within the embedded attributes. The proctoring instructions are adapted and extended within extender module 215 to present dynamic content through two-way data-binding for automatic synchronization of models and views between device 135A/B and command center 125. Extender module 215 may decouple document object model (DOM) manipulation from application logic deriving from react client 205. DOM is a cross-platform and language-independent application programming interface that treats an extensible hypertext markup language (XHTML), HTML, or XML documents as a logical tree structure. Each branch of the logical tree ends in a node, wherein each node contains objects. DOM methods allow programmatic access to the logical tree to change the structure, style, or content of a document. Nodes can have event handlers attached to them. Once an event is triggered, the event handlers are executed.

In an embodiment, access module 220 within proctor module 110 enforces security protocols and end-user access. End-users, such as proctors using devices 135A-B and examinees using registration center 127, may be authenticated through social identity providers (Google®, Facebook®, and Amazon®) or enterprise identity providers (Microsoft®). Access module 220 is a logical circuit configured to define and map the roles of end-users. For example, examinees may not access proctor module 110 and devices 135A-B only obtain messages from command center 125. Identity management and authentication standards used by access module 220 are compliant with PCI DSS, SOC, ISO/IEC 27001, ISO/EIC 27017, ISO/EIC 27018, and ISO 9001 standards. Additionally, access module 220 uses adaptive authentication to enhance the security of proctor module 110 from unauthorized access. For example, if access module 220 detects unusual sign-in activity, such as sign-in attempts from locations and devices not associated with the proctor, the proctor is prompted for additional verification or the sign-in request is blocked. Encryption techniques are applied to encode a message or information such that only proctors can access the contents of the message sent from command center 125. Proctors are end-users that have the required keys for decrypting ciphertext from the sent message into intelligible plaintext.

In an embodiment, API Gateway 225 is a set of subroutine definitions, communication protocols between various components, and tools in proctor module 110 for building software. API Gateway 225 is a logical circuit configured to obtain the other building blocks needed to support the digitization and standardization of proctoring. API Gateway 225 is compatible with a web-based system, operating system, database system, computer hardware, or software library. The specifications of API Gateway 225 are directed to routines, data structures, object classes, variables, or remote calls, while preventing certain aspects of a class or software component from being accessible to unauthorized end-users via programming language features (e.g., private variables) or an explicit exporting policy.

In an embodiment, cloud module 230 is a cloud computing platform in proctor module 110 for allowing end-users to use virtual computers. Cloud module 230 allows scalable deployment of applications by providing a web service through which end-users can configure a virtual machine which contains the desired application. Cloud module 230 is a logical circuit configured to control the geographic location of virtual machines, leading to latency optimization (i.e., time delay functions) and elevated levels of redundancy (i.e., duplication of critical components for increasing reliability or performance of a system). The cloud computing platform contains shared pools of configurable computer system resources and higher-level services that can be rapidly provisioned with minimal management effort, often over the Internet. In this embodiment, command center 125 is a cloud server that provisions and provides higher-level services to client devices, such as devices 135A-B and registration center 127. The cloud computing platform supported by cloud module 230 reduces up-front IT infrastructure costs, while simultaneously connecting command center with different proctors and different testing sites. For example, device 130A in room 135A resides in district 1 and device 130B in room 135B resides in district 2. Districts 1 and 2 are two different neighborhoods in the same city experiencing adverse weather conditions. Through cloud module 230, command center 125 can simultaneously inform the proctors in these two testing sites, due to the adverse weather conditions, that: (i) any test that takes 4 hours or longer will be cancelled; and (ii) examinees must leave the testing site.

In an embodiment, RDS module 235 is a stored procedure package within proctor module 110 for accessing and controlling an RDS (e.g., database 120). RDS module 235 is a logical circuit configured for integrating data-validation into database 120 and access-control mechanisms. Database management system (DBMS) forms by combing RDS module 235 in proctor module 110 and database 120. The functions and services provided by this DBMS supports the: (i) storage, retrieval, and update of data, including encryption information of each examinee; (ii) description of metadata in user accessible catalog; (iii) support for transaction and concurrency; (iv) facilities for recovering contents if database 120 becomes damaged; (v) support for authorization of access and update of data; (vi) access support from remote locations; and (vii) constraints that ensure data in database 120 abides by certain rules. In an example, RDS module 235 is invoked by proctor module 110 to obtain profile information of examinees, proctoring instructions, and seating charts from database 120.

In an embodiment, analytics module 240 is a module within proctor module 110 for receiving and sending information and data from database 120 via RDS module 235; sensors 115 via edge compute 245; and UI 105 via react client 205, web module 210, extender module 215, access module 220, and cloud module 230. More specifically, analytics module 240 is a logical circuit configured to perform machine learning techniques. Machine learning aids proctor module 110 in performing the following functions: (i) presenting the proctoring instructions to UI 105 in devices 135A-B; (ii) compiling information from edge compute 245 and RDS module 235; (iii) comparing digitally captured information at testing sites via edge compute 245 and information established in database 120 within command center 125 via RDS module 235; (iv) processing encrypted information for validating or invalidating authentication of examinees; (v) identifying aberrant conditions or behaviors in the testing sites; (vi) validating or invalidating testing conditions based on a severity and influence of the aberrant conditions; and (vii) devising solutions to the identified aberrant conditions or behaviors.

In an embodiment, edge compute 245 is an interfacing module within proctor module 110 connected to sensors 115 to establish edge computing systems and methods. As described above, devices 135A-B are edge nodes that make contact with the physical world, for example, the examinees and the conditions to which the examinees are exposed to. The edge computing digitally captures information/data on the testing environment.

In some embodiments, machine learning is used to examine and collect statistics or informative summaries of contents across information at testing sites via edge compute 245 and extracted information established by command center 125 via RDS module 235. This triggers metadata creation to understand the relevance, quality, and structure of the information/data contained within information at testing sites via edge compute 245 and extracted information established by command center 125 via RDS module 235. Edge compute 245 and RDS module 235 contain information in different formats. Subsequently, data quality procedures of the machine learning techniques, as applied by proctor module 110, eliminate duplicate information, match common records, standardize formats, and extracts the contents from edge compute 245 and RDS module 235. In turn, proctor module 110 is able to identify irregularities during the proctoring and evaluation of tests via machine learning techniques.

Machine learning techniques may include a convolutional neural network (CNN), decision tree, linear regression, or other types learning algorithms that are implemented by proctor module 110. In some examples, the machine learning algorithm may be trained using a training data set. The training data set may be generated by compiling contents from information at testing sites via edge compute 245 and information in database 120 within command center 125 via RDS module 235. The training data set may also include information created from end-user input provided through a graphical user interface and/or by scanning paper sources. In some examples, multiple training sets may be generated from the same individual training content source. The machine learning model may then be trained using large quantities (hundreds or thousands) of training data. During the training process, user input may be obtained to adjust model parameters to increase the efficiency at standardizing the proctoring process.

In some embodiments, analytics module 240 within proctor module 110 applies machine learning methods for performing functions that identifies and reduces irregularities during the proctoring process via supervised learning. While not necessarily in this order, supervised learning may include the following functions: (i) analyzing contents within database 120 by correlating behaviors and events associated with ideal and non-ideal testing conditions; (ii) constructing prediction models based (e.g., an irregularity determination model) on the analyzed contents; (iii) training the prediction models using a training set within database 120; (iv) validating the prediction models using a testing set within database 120; (iv) evaluating the accuracy of the prediction models; (v) refining the prediction model if the accuracy is at unsatisfactory level based on a threshold by repeating supervised learning functions (i)-(iv); (vi) retrieving digitally captured information from testing site; (vii) applying the prediction model that evaluates the digitally captured information at multiple testing sites if the accuracy is at a satisfactory level based on the threshold; (viii) comparing the prediction model evaluations with human evaluations; (ix) repeating supervised learning functions (ii)-(ix) if the agreement between the prediction model evaluations and human evaluations is not at an acceptable level based on threshold; (x) parsing through the digitally captured information to determine if there are non-suspicious, non-triggering behaviors; and suspicious, triggering behaviors; (xi) making decisions on the suspicious, triggering behaviors to reduce irregularities during the proctoring process; (xii) updating database 120 with the decisions of the suspicious, triggering behaviors; (xiii) training the prediction model or building new models with the updated database 120; and (xiv) refining and validating the prediction model or new models by repeating supervised learning functions (x)-(xiv).

With respect to supervised learning functions (x)-(xiii) above, the machine learning generated model may make decisions that can devise solutions related to the contents within database 120 and digitally captured information from testing sites. More specifically, the machine learning models examine the contents within database 120 to develop behavioral profiles. Database 120 is a repository that includes behavioral profiles associated with ideal testing and non-ideal testing conditions. Non-suspicious and non-triggering behaviors are characteristics of ideal testing conditions, such as examinees staying seated during the entirety of the exam; beginning on and ending the exam as dictated by the proctor; and quietly taking the exam. In contrast, suspicious and triggering behaviors are characteristics of non-ideal testing conditions, such as examinees frequently leaving the testing site during the duration of the exam; not beginning and ending the exam as dictated by the proctor; and noisily taking the exam. On the day of exam, proctor module 110 in devices 135A and 135B monitors the behavior of the examinees in sites 130A and 130B, respectively. The behaviors of the examinees, which are digitally captured by proctor module 110, are sent to command center 125.

A behavioral index is generated by comparing the behaviors of examinees digitally captured by proctor module 110 in devices 135A and 135B to the behavioral profiles in database 120. Behavioral indexes that align more closely with the non-suspicious and non-triggering behaviors are not further investigated by the end-user operating command center 125 or proctors operating device 135A and 135B. In contrast, behavioral indexes that align more closely with the suspicious and triggering behaviors are further investigated by the end-user operating command center 125 or proctors operating devices 135A and 135B. For example, the machine learning in proctor module 110 in command center 125 identifies two examinees in the same building are leaving their respective testing site at the same time and flags this as suspicious behavior aligned more with more non-ideal testing conditions. Database 120 contains counteractions to be implemented when behaviors elicit a behavioral index indicative of non-ideal testing conditions. If counteractions to the identified suspicious behaviors are not contained within database 120, then proctor module 110 uses machine learning to devise a counteraction, which is sent as a message to the appropriate proctors. The devised counteraction is based on similarity levels of the identified suspicious behaviors to those counteractions correlated with the suspicious behaviors contained within database 120.

A behavioral index may similarly be generated for each proctor by comparing the actual proctoring steps digitally captured by proctor module 110 to the instructions given to the proctor. Stated another way, the similarity level between the instructions given to the proctor and the actual proctoring steps performed by the proctors is determined by proctor module 110. High similarity levels are indicative of proctors closely following the instructions given to them and thus removing variability during the proctoring process. Testing environment conditions (e.g., temperature, humidity, and if there are burst pipes or stray animals in the testing site) are digitally captured by proctor modules 110 on devices 135A and 135 at sites 130A and 135B, respectively. The characteristics of ideal and the different types of non-ideal testing conditions, such as burst pipes, for a testing site are contained within database 120. The characteristics of the conditions are compared to digitally captured testing environment conditions. The comparisons are used to construct a testing environment index for quantifying a similarity level to ideal and non-ideal testing conditions. A testing environment index that aligns more closely with non-ideal conditions indicate that disruptive conditions negatively impact the examinees.

The functions performed by machine learning techniques, as applied by proctor module 110, leverage syntax and semantics that may be executed on devices 135A-B and command center 125. The syntax and semantics are used in combination with training and testing matrixes; associative arrays containing unordered key-value-pairs; iterable objects; confusion matrixes; multinomial naïve Bayes; linear support vector classification machine learning algorithms; and base estimators. Averaging and boosting methods are base estimators for reducing biases and increasing the robustness and generalizability of a constructed prediction model. As noted above, there are specific behaviors established within database 120 associated with non-ideal testing conditions. During the test, there may be other digitally captured behaviors that align more with closely with non-ideal testing conditions. However, these other digitally captured behaviors are not contained within database 120. Thus, proctor module 110 may be limited to those specific behaviors contained within database 120 and not process these other digitally captured behaviors, without the base estimators.

With respect to training and testing matrixes, a data set retrieved from database 120 are split and transformed with dummy variables. For example, 30% of the data set is treated as a testing set and 70% of the data is treated as a training set, where the test size is 0.3. Moreover, the training matrix and testing matrix extract features or characteristics from 70% and 30% of the data set, respectively, for transformation by dummy variables and concatenation. The models (e.g., the irregularity determination model), as supported by multinomial naïve Bayes and linear support vector classification machine learning algorithms, may be fitted to the concatenated training matrix. The fitted models leverage the concatenated testing matrix to obtain predicted probabilities or other insights. The confusion matrix is derived from the testing matrix for identifying true positive, true negative, false positive, and false negative relations. These relations further characterize and corroborate flagged behaviors and events that cause or do not cause variations, irregularities, and disruptions during the proctoring process. For example, a proctor does not seat the examinees exactly as the seating chart indicated due a chair unexpectedly breaking. The proctor has no choice but to sit the examinee in another chair. This is digitally captured by proctor module 110 and flagged as potentially non-ideal. The flagged behavior or event is not causing irregularities during the proctoring process and thus not correlated with non-ideal behaviors negatively impacting examinees. Moreover, the sensitivity, which is the measure of the true positive rate (e.g., the proportion of actual flagged events correctly identified as non-ideal) and specificity, which is the measure of true negative rate (e.g., the proportion of actual non-flagged events correctly identified as ideal) can be increased by applying cutoff parameters to the machine learning algorithms.

FIG. 3 is a computing environment for registering test takers. Environment 300 is a more detailed depiction of registration center 127, which is controlled by proctor module 110. Device 305 may be a desktop, laptop, or any programmable computer device that connects to scanner 310, monitor 315, keyboard 320, mouse 325, and camera 330. Scanner 310 and camera 330 obtain: (i) photographs in state-issued identification documents; and (ii) distinctive and measurable physiological characteristics for labeling and describing examinees. Some of examples of physiological characteristics include fingerprints, palm veins, face recognitions, palm prints, DNA, hand geometries, iris recognitions, and retinas. Monitor 315 contains UI 105 to enter examinee information via keyboard 320 and mouse 325. Additionally, scanner 310 can process encrypted data in tokens provided to each examinee. These tokens create a digital signature for each examinee.

Examinee information entered into UI 105 of monitor 315 may be the name of the examinee, test to be taken, and state issued identification that needs to be processed. Profile information is generated prior to the examination data when an examinee signs up to take a test. This profile information is collected and stored in database 120. Upon entering examinee information into UI 105 of monitor 315, proctor module 110 compares the entered examinee information to the profile information in database 120. Any inconsistencies, such as nonmatching social security numbers and birthdates, may be immediately identified by proctor module 110. Anytime an examinee leaves and enters the testing site, camera 330 takes a front and side views of each examinee, which are sent to database 120. The machine learning applied by proctor module 110 examines the quality of an image and compares subsequent images to prior images. If the pixel quality is not high enough, then machine learning notifies proctor module 110 in command center 125 and instructs the examinee and proctor that another image is needed. More specifically, instances of compared images suggesting that the examinee do not appear identical are flagged as potentially problematic and sent to command center 125. Additionally, not all images of each examinee may be of the same quality. Machine learning algorithms can compare resolution and pixels to ensure that all images of examinees are of equal quality and sufficiently comparable to each other. More specifically, machine learning applied by proctor module 110 establishes a baseline associated with an examinee when initially registered. Subsequent images of the examinees are compared, while correcting for modifications in the appearance of the examinees, such as examinees sweating or getting disheveled hair which may alter image quality, by proctor module 110 applying machine learning.

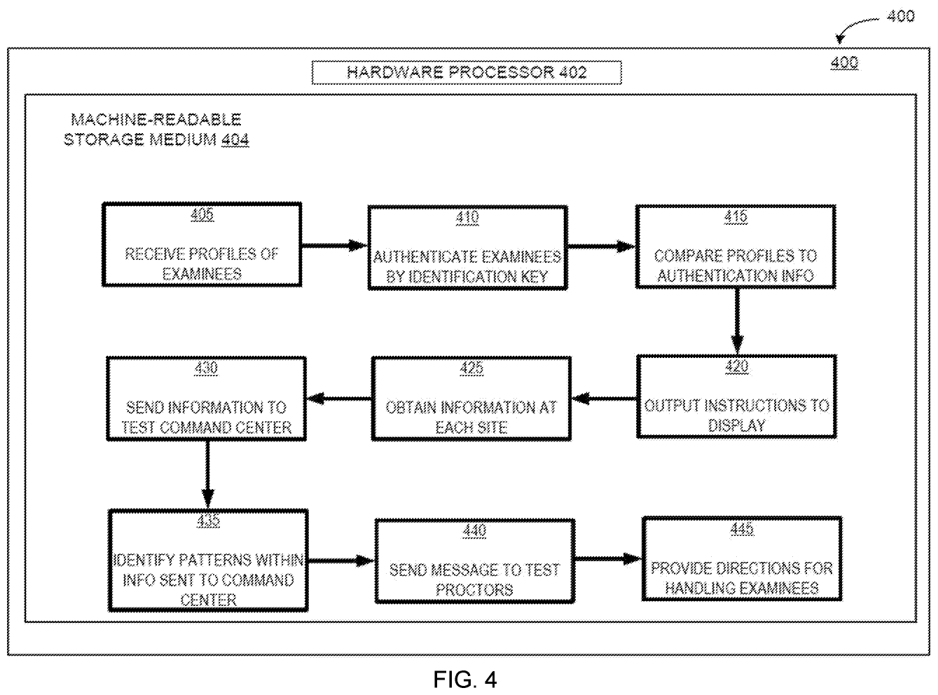

FIG. 4 is an example of a flowchart of the functions performed for supporting a digitized and interactive toolset when proctoring examinations. More specifically, computing component 400 on devices 130A-B furnishes an efficient and linearized system for standardizing the proctoring of examinations. In the example implementation of FIG. 2, the computing component 400 includes hardware processor 402 and machine-readable storage medium 404.

Hardware processor 402 may be one or more central processing units (CPUs), semiconductor-based microprocessors, and/or other hardware devices suitable for retrieval and execution of instructions stored in machine-readable storage medium 404. Proctor module 110 invokes hardware processor 402 to fetch, decode, and execute instructions as steps 405; 410; 415; 420; 425; 430; 435; 440; and 445.

As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 402 may be a non-transitory storage medium, where the term “non-transitory” does not encompass transitory propagating signals. As described in detail below, machine-readable storage medium 402 may be encoded with executable instructions, such as the steps in the flowchart in FIG. 4.

Proctor module 110 receives profiles of examinees, at step 405. In some embodiments, proctor module 110 uses machine learning techniques to distinguish examinees assigned to a proctor from those not assigned to proctor. For example, the proctor operating device 135A has a different list of examinees assigned to site 130A from the proctor operating device 135B assigned to site 130B. The obtained profiles include the subject the examinee will be tested on and the amount of time the examinee will have to finish the test.

Proctor module 110 authenticate examinees by identification keys, at step 410. Each examinee must sign up for a test by indicating the date, location, and subject of the test. The identification key may be a token sent to a mobile device of an examinee. The token, which may be presented to sensor 310 in registration center 127, establishes a digital certificate of each examinee. As stated above, proctor module 110 controls registration center 127, where each examinee enters his/her respective credentials to register at the testing site on the day of the test. Only those examinees appropriately registered on the day of the test are allowed entry to sites 130A-B.

Proctor module 110 compare profiles to authentication information, at step 415. In some embodiments, profiles of examinees contain information that does not match the authentication information entered in registration center 127 by each examinee. Examinees are required to present valid identifications and encryption keys. Proctor module 110 in command center 125 can detect inconsistencies between obtained profile and the examinee-entered authentication information in real-time and send an encrypted message to proctor module 110 at the appropriate devices. If an examinee registering at site 130A enters registration information that does not match with the profile of examinee, such as non-matching social security numbers, the proctor operating device 135A is informed in real-time.

Proctor module 110 outputs instructions to a display, at step 420. The instructions may be aligned to the delivery of the paper-based test or digitized tests in tablet devices. Proctor module 110 generates respective testing room diagrams on mobile devices, such as devices 135A-B. As stated above, device 135A is associated with site 130A, whereas device 135B is associated with site 130B. Accordingly, the testing room diagram generated by proctor module 110 in device 135A and the required exams for site 130A are different from the testing room diagram generated by proctor module 110 in device 135B and the required exams for site 130B. Proctor module 110 at command center 125 may again apply machine learning techniques, which processes the profile information of all examinees and generated testing room diagrams. Based on the examinee profiles, different testing sites require different exams. For example, site 130A has examinees taking chemistry; physics; economics; and college admissions tests, whereas site 130B has examinees taking English, French, and German tests. On the day of tests, the instructions presented to the proctor operating device 130A are different than the instructions presented to the proctor operating device 130B via proctor module 110 from command center 125. These instructions account for the number of seats available; the different tests needed; and sequences for delivering tests and collecting the tests for each site.

Proctor module 110 obtains information at each site, at step 425. The edge computing allowed by proctor module 110 in device 130A puts a time stamp on events that take place in site 135A. Similarly, proctor module 110 in device 130B puts a time stamp on events that take place in site 135B. The events digitally captured by proctor module 110 may be local or global events. Local events impact a single examinee in a testing site, such as stepping out of and returning back to the testing site. Global events impact multiple examinees in a testing site or across testing sites, such as a pipe bursting; an animal scurrying across a testing site; or fire alarm going off. The digitally captured local and global events contribute to testing environment index described above. Additionally, the sequence by which the tests are distributed by each proctor is digitally captured by proctor module 110.

Proctor module 110 sends information to the test command center (e.g., command center 125), at step 430. More specifically, the information digitally captured by proctor modules 110 in device 130A and 130B is immediately sent to proctor module 110 in command center 125 in real-time. Analysis may be done using machine learning techniques applied by proctor module 110 in command center 125. The information sent to command center 125 is compared to information, such as a profile information and testing conditions deemed ideal, residing within database 120.

Proctor module 110 identifies patterns within information sent to test command center, in step 435. Patterns requiring further action are associated with the digitally captured irregularities. In one example, proctor module 110 in device 135A may use the edge computing and machine learning capabilities to inform command center 125 in real-time that a pipe burst. More specifically, a pipe bursting is an irregularity that is digitally captured, which is a global event sent to command center 125. In another example, proctor modules 110 in device 135A-B note when Examinees A and B enter and leave sites 130A and 130B, respectively. This information, which is sent to proctor module 110 in command center 125, is obtained in real-time. Machine learning identifies a pattern in this example where Examinees A and B leave the respective testing sites and return at the same time as each other. Additionally, sites 130A and 130B are in the same building. The profiles of Examinees A and B indicate that Examinee A took the same test as Examine B a month ago. Furthermore, the time stamps and the location of Examinees A and B may suggest these examinees are inappropriately discussing their tests with each other. In this example, the digitally captured irregularities are local events at a respective testing site which may require further action on behalf of the proctors. In yet another example, the sequence each proctor distributes paper-based tests to each examinee at each site is digitally captured by proctor module 110. If a proctor does not follow the sequence indicated in the instructions sent to proctor module 110 on each device, proctor module 110 in command center 125 is notified immediately.

Proctor module 110 sends messages to test proctors, in step 440. More specifically, proctor module 110 at command center 125 sends messages to the desired proctors. In the above example of digitally captured irregularities that are local events, proctor module 110 at command center 125 sends an encrypted message to proctor module 110 on device 135A and another encrypted message to proctor module 110 on device 135B. These two encrypted messages are different from each other and require a different decrypting key. The decrypting key on device 135A can only be accessed by the proctor operating device 135A to convey that Examinee A may be engaging in suspicious behavior. Similarly, the decrypting key on device 135B can only be accessed by the proctor operating device 135B to convey that Examinee A may be engaging in suspicious behavior. If a local or global event impacts an examinee or examinees, respectively, in site 130A, then proctor module 110 in device 135A receives the message from proctor module 110 in command center 125.

Proctor module 110 provides directions for handling examinees, in step 445. The information obtained by command center 125 is compared to information in database 120. Database 120 contains ideal testing and proctoring conditions which establishes a baseline associated with a perfectly administered test. If deviations within the information obtained by command center 125 are observed in comparison to the established baseline, then proctor module 110 correlates an irregularity, such as the local and global events, with the deviations. The machine learning examines profiles of each examinee and contents in database 120. A model is then generated to correct or alleviate the irregularities caused by a local or global events. This model provides a solution to remove the deviations, wherein the solution is contained within the message. In the example above of digitally captured irregularities that are local events, the message sent to proctor module 110 in device 130A instructs the proctor to not permit Examinee A from leaving site 135A because Examinee B requested to leave site 135B. The real-time functionality of proctor module 110 allows proctors to thwart attempts at cheating. In the example above of the digitally captured irregularities that are global events, the message sent to proctor module 110 in device 135A is to evacuate site 130A and collect all tests even if some or all of the tests are soaked in water. Once all proctoring tasks are completed, the standardized examination experience is considered closed. Proctor module 110 uses time stamps and thus, any tasks digitally recorded after the examination experience is closed are sent to command center 125 and flagged as suspicious.

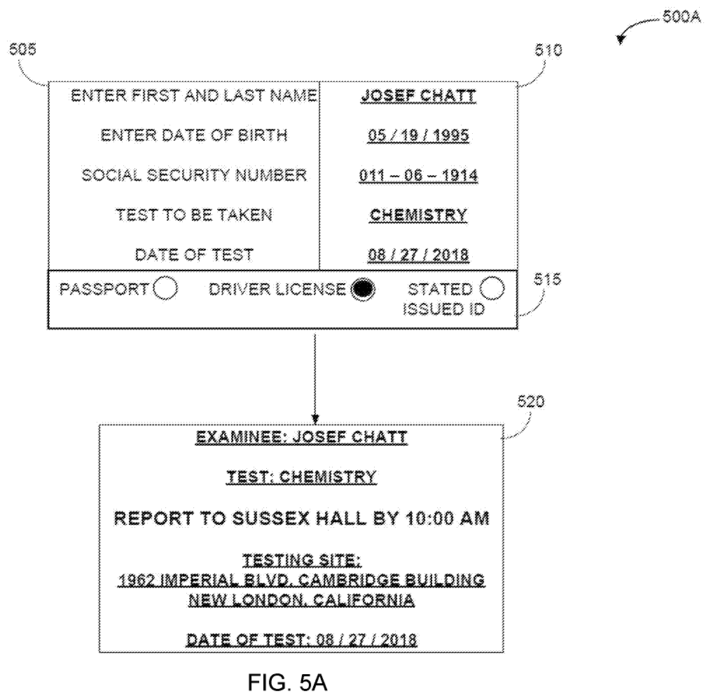

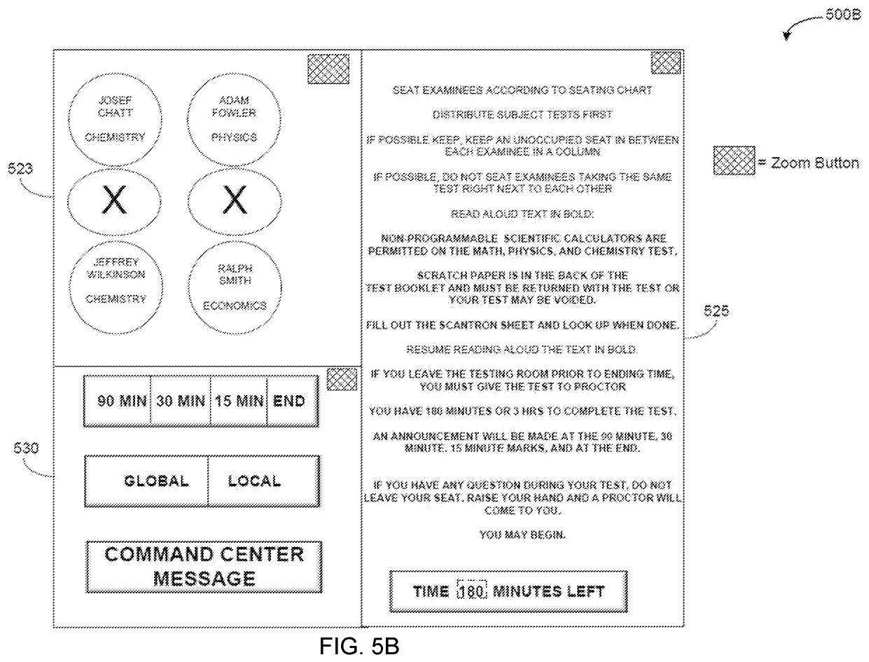

FIG. 5A is an example of a user interface supported by the devices for supporting a digitized and interactive toolset when administering standardized examinations. GUI 500A contains GUI portions 505, 510, 515, and 520. GUI portions 505, 510, and 515 are allowed to be presented to each examinee registering for a test on registration center 127, as supported by proctoring module 110. GUI portion 505 corresponds to GUI portion 510 for entering in the following information for an examinee: first and last name, date of birth of, social security number, test to be taken, and date of the test. In GUI portion 515, the examinee selects the type of identification he or she wishes to present for registration. Upon processing an examinee, GUI portion 520 is presented to an examinee and the proctor. This ensures that the proctors and examinees are receiving the same information as it pertains to reporting to an exact testing site. In this example, GUI 520 is presented to “Josef Chatt”, who is an Examinee, at a UI 105 and to proctor at “Sussex Hall” in “1962 Imperial BLVD, Cambridge Building, New London, California” on “8/27/2018”.

FIG. 5B is another example of a user interface supported by the devices for supporting a digitized and interactive toolset when administering standardized examinations. GUI 500A contains GUI portions 523, 525, and 530. GUI portions 523, 525, and 530 are presented to a proctor via proctor module 110 within a device operated by the proctor; and contain a zoom button. GUI portion 523 depicts a testing room diagram with a seating chart. The examinee names and the test the examinee is taking are listed in the seats they are supposed to occupy. The examinees Josef Chatt and Jeffrey Wilson, who are taking a chemistry test, occupy seats in the same column as each other and separated by an unoccupied seat indicated by “X”. Examinees Adam Fowler and Ralph Smith, who are taking a physics test and economics test, respectively, occupy seats in the same column as each other and separated by another occupied seat indicated by “X”. GUI portion 125 contains the instructions presented to the proctor and button indicating how much time is left. When the button is pressed by the proctor, the timing starts. Within the dotted box, the time remaining is indicated. GUI portion 530 contains a “Command Center Message” button; “global” and “local” buttons; a “90 min”, “30 min”, “15 min”, and “end” buttons. If a message is obtained from proctor module 110 in command center 125, the “Command Center Message” changes from greyed out to blackened. The blackened button may be pressed by the proctor to access the obtained message. The “global” or “local” buttons glow when a global event or local event is detected by proctor module 110. A time stamp and description (e.g., examinees leaving and entering a testing site, and pipe bursting) are automatically digitally captured with each detected global and local event. Additionally, when an examinee receives the test for the first time by the proctor and turns in the test to the proctor, the local button glows. Prior to reaching the 90-minute mark, 30-minute mark, 15-minute mark, and the end of the testing time are reached, “90 min”, “30 min”, “15 min”, and “end” buttons are blackened. When each of these marks, the “90 min”, “30 min”, “15 min”, and “end” buttons glow, respectively. After reaching each of these marks, “90 min”, “30 min”, “15 min”, and “end” buttons are greyed out.

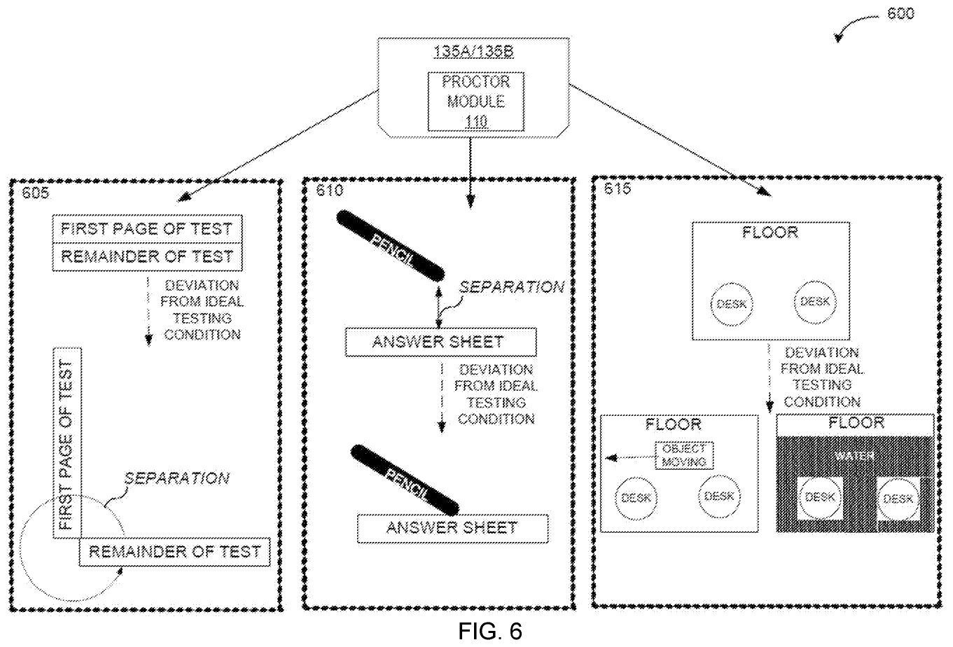

FIG. 6 is an illustration of local and global factors detectable by the device for supporting a digitized and interactive toolset when administering standardized examinations. Testing environment 600 contains proctoring module 110 residing within device 135A or 135B.

In an embodiment, instance 605 depicts a testing booklet. Prior to beginning a test, the testing booklet is to remain closed. Thus, the first page of the test, or portion of the test containing the first page, must be directly on top of the remainder of the test. This means there is no separation between the first page of the test, or the portion of the test containing the first page, and remainder of the test. If there is a separation greater than 0 degrees between first page of the test, or the portion of the test containing the first page, and remainder of the test, then the examinee may be trying to start taking the test prior to the time he or she is authorized to. The proctor may not be able to keep track of every examinee while attending to other examinees or providing instructions. Any detected separation prior starting the timing is a digitally captured irregularity that is a local factor and accompanied with a time stamp. The digitally captured irregularity and time stamp are immediately sent to proctor module 110 in command center 125 from proctor module 110 in device 135A or 135B.

In an embodiment, instance 610 depicts an answer sheet and writing utensil, such as a pencil. Upon time for a test expiring, the examinee is not supposed write with a pencil on paper, such as the answer sheet. This means there is a separation between the answer sheet and pencil. If there is no separation greater between the answer sheet and pencil, then the examinee may be trying to answer questions on the test after the time he or she is authorized to. The proctor may not be able to keep track of every examinee while attending to other examinees or providing instructions. A lack of separation after time expires is a digitally captured irregularity that is a local factor and accompanied with a time stamp. The digitally captured irregularity and time stamp are immediately sent to proctor module 110 in command center 125 from proctor module 110 in device 135A or 135B.

In an embodiment, instance 615 depicts the floor of the testing site and accompanying desks where examinees would sit. Prior or during the examination, there should be no object moving or water accumulating along the floor near the desks. This may be indicative of a stray animal or flooding due to a pipe bursting. The ideal testing condition is set as the baseline using machine learning. An object moving and water accumulating near multiple desks where examinees are sitting may be indicative of irregularities that are global factors. The digitally captured irregularity is accompanied with a time stamp that is immediately sent to proctor module 110 in command center 125 from proctor module 110 in device 135A or 135B.

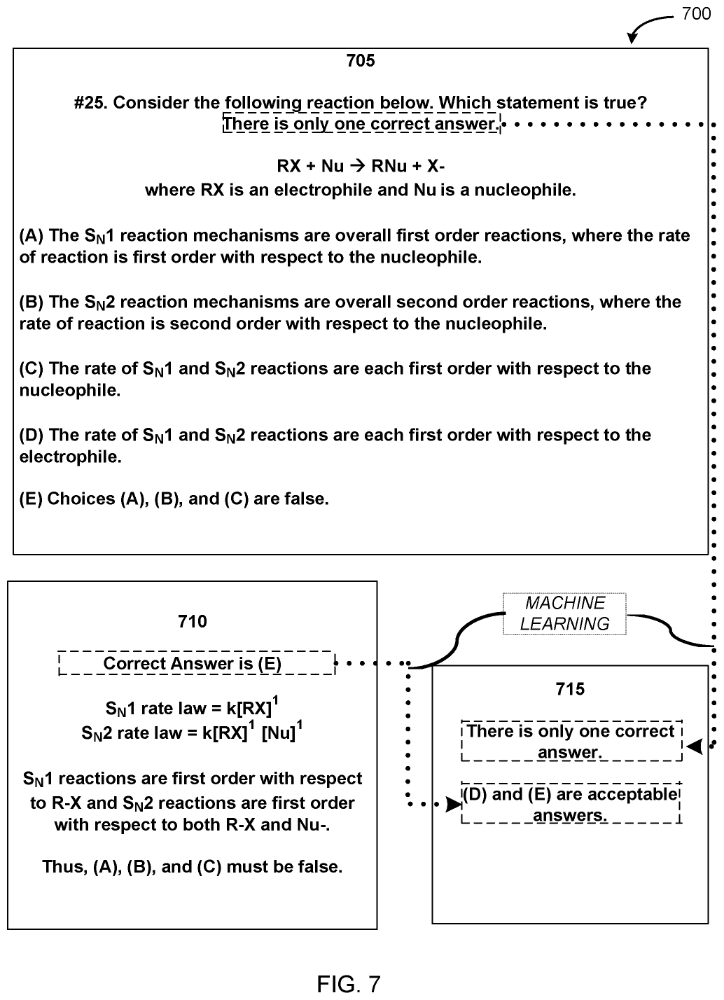

FIG. 7 is an example of a depiction of a question and associated answer key on which irregularities are identified. Test 700 contains question 705, answer key 710, and machine learning identification 715. Assessment module 210 may be applied to question 705. Comments and “reasons” arrays, described above, may be leveraged with syntax amenable to the clean up the formatting in question 705 and answer key 710 such that machine learning can be applied. In an embodiment, an irregularity is “flagged” by assessment module 210. A decision tree is constructed to determine if question 705 and answer key 710 are consistent with each other. Question 705 indicates that there is only one correct answer, which is choice (E) as indicated in answer key 710. However, choice (D) is also a correct statement consistent with the fact pattern posed in question 705. Thus, assessment module 210 identifies “There is only one correct answer” as not being consistent with answer key 710. The machine learning also provides a solution by accepting (D) and (E) as acceptable answers to question 705.

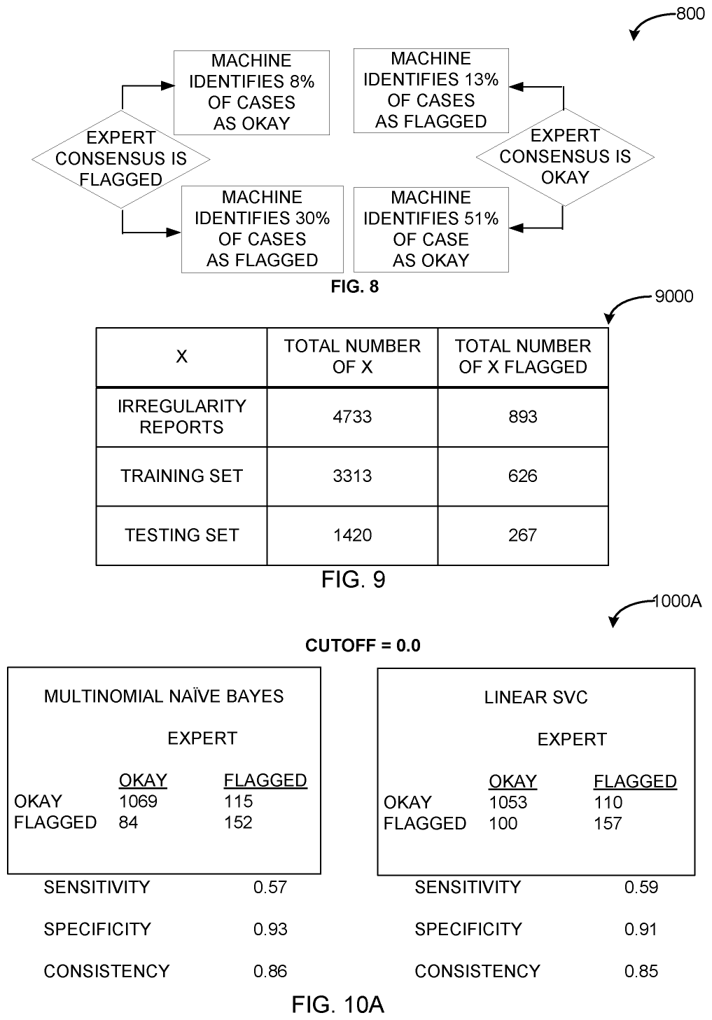

FIG. 8 is an example depiction summarizing true positive, true negative, false positive, and false negative outcomes of applying the supervised learning steps for identifying irregularities. Summary 800 indicates that there is high agreement between a machine using assessment module 210 and human experts is high. For a first set cases the human expert consensus is “flagged”, assessment module 210 identifies 8% of the first set of cases as “okay” and 30% of the first set of cases also as “flagged”. For a second set of cases the human expert consensus is “okay”, assessment module 210 identifies 13% of the second set of cases as “flagged” and 51% of the second of cases also as “okay”. Thus, assessment module 210 correctly identifies 81% of the total number of cases as the experts would have. For the cases assessment module 210 does not agree with the experts, assessment module 210 tends to flag more cases than not.

FIG. 9 is an example of a table summarizing irregularity reports, training sets, and training sets flagged for irregularities by the supervised learning steps. In table 9000, X=irregularity reports, training set, and testing set, where the total number of cases of X and the total number of cases of X flagged are listed. The total number of cases in the training and testing sets equal the total number of cases of irregularity reports.

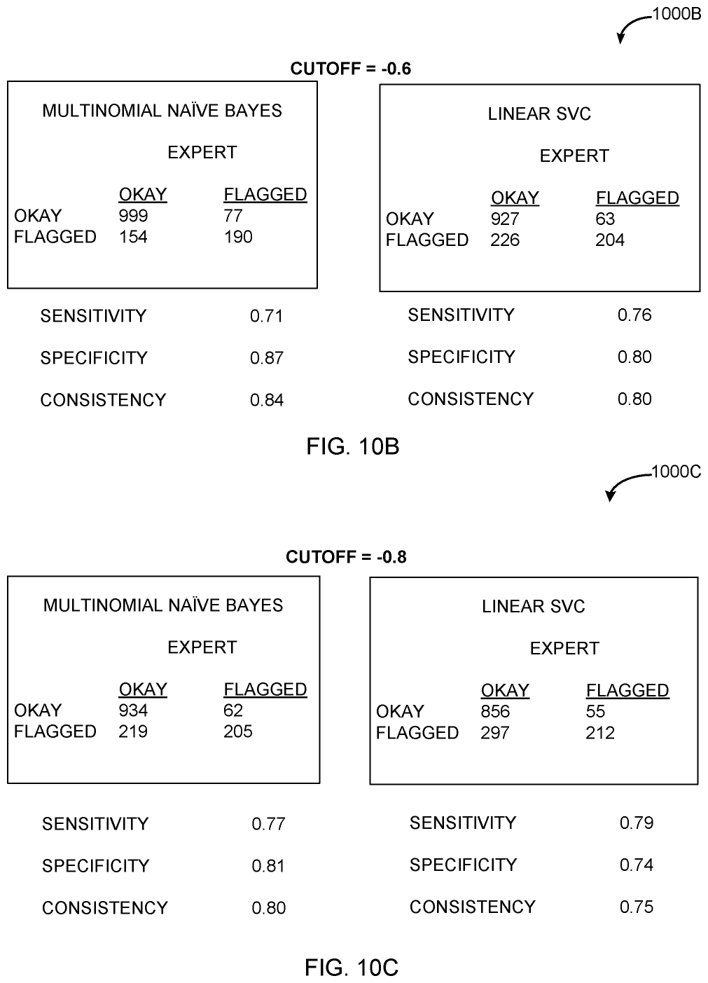

FIG. 10A, FIG. 10B, and FIG. 10C are example of a table summarizing instances identified as “okay” and “flagged” by the supervised learning steps and a human expert with different cutoff values.

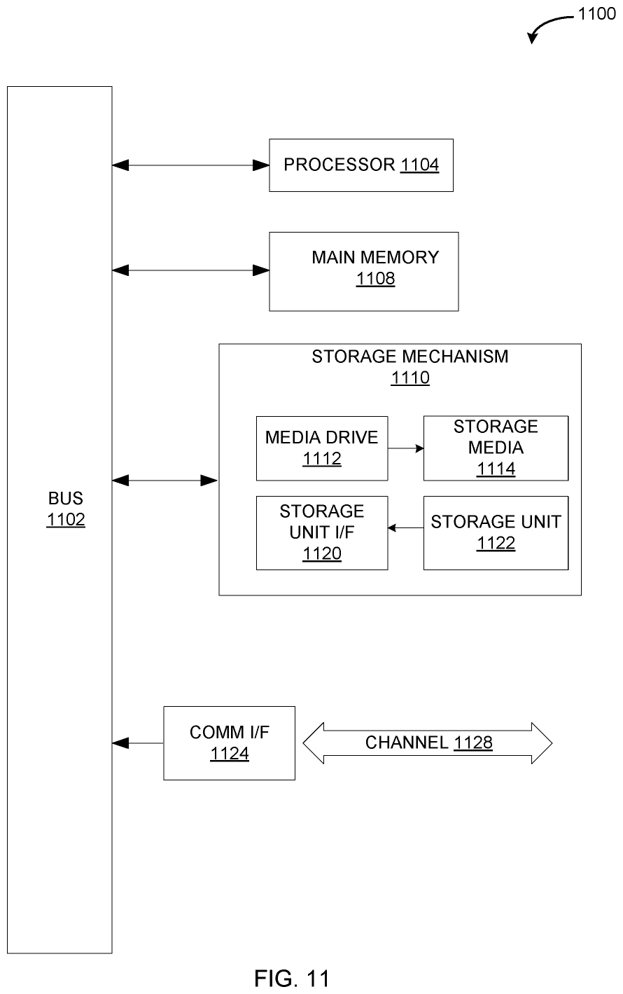

Confusion matrices 1000A, 1000B, and 1000C corresponds to the total number of cases of testing sets (1420) and number of cases of testing sets flagged (267) in FIG. 9. Multinomial naïve Bayes model and linear SVC models in FIG. 10A, FIG. 10B, and FIG. 10C correspond to the first confusion and second confusion matrices in FIG. 5. In FIG. 10A, the cutoff is 0.0. In comparison to the sensitivity in FIG. 10A, the sensitivity increases in FIG. 10B and FIG. 10C when the cutoff of −0.6 and −0.8 are applied, respectively. Furthermore, the sensitivity in FIG. 10C is higher than the sensitivity in FIG. 10B. As the sensitivity increases in FIG. 10B and FIG. 10C, the specificity decreases.

Where components, logical circuits, or engines of the technology are implemented in whole or in part using software, in one embodiment, these software elements can be implemented to operate with a computing or logical circuit capable of carrying out the functionality described with respect thereto. One such example logical circuit is shown in FIG. 11. Various embodiments are described in terms of this example logical circuit 1100. After reading this description, it will become apparent to a person skilled in the relevant art how to implement the technology using other logical circuits or architectures.

Referring now to FIG. 11, computing system 1100 may represent, for example, computing or processing capabilities found within desktop, laptop, and notebook computers; hand-held computing devices (PDA's, smart phones, cell phones, palmtops, etc.); mainframes, supercomputers, workstations, or servers; or any other type of special-purpose or general-purpose computing devices as may be desirable or appropriate for a given application or environment. Logical circuit 1100 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 1100 might include, for example, one or more processors, controllers, control engines, or other processing devices, such as a processor 1104. Processor 2104 might be implemented using a general-purpose or special-purpose processing engine such as, for example, a microprocessor, controller, or other control logic. In the illustrated example, processor 1104 is connected to a bus 1102, although any communication medium can be used to facilitate interaction with other components of logical circuit 2100 or to communicate externally.

Computing system 1100 might also include one or more memory engines, simply referred to herein as main memory 1108. For example, preferably random-access memory (RAM) or other dynamic memory, might be used for storing information and instructions to be executed by processor 1104. Main memory 1108 might also be used for storing temporary variables or other intermediate information during execution of instructions to be executed by processor 1104. Logical circuit 1100 might likewise include a read only memory (“ROM”) or other static storage device coupled to bus 1102 for storing static information and instructions for processor 1104.

The computing system 1100 might also include one or more various forms of information storage mechanism 1110, which might include, for example, a media drive 1112 and a storage unit interface 1120. The media drive 1112 might include a drive or other mechanism to support fixed or removable storage media 1114. For example, a hard disk drive, a floppy disk drive, a magnetic tape drive, an optical disk drive, a CD or DVD drive (R or RW), or other removable or fixed media drive might be provided. Accordingly, storage media 1114 might include, for example, a hard disk, a floppy disk, magnetic tape, cartridge, optical disk, a CD or DVD, or other fixed or removable medium that is read by, written to, or accessed by media drive 1112. As these examples illustrate, the storage media 1114 can include a computer usable storage medium having stored therein computer software or data.

In alternative embodiments, information storage mechanism 1140 might include other similar instrumentalities for allowing computer programs or other instructions or data to be loaded into logical circuit 1100. Such instrumentalities might include, for example, a fixed or removable storage unit 1122 and an interface 1120. Examples of such storage units 1122 and interfaces 1120 can include a program cartridge and cartridge interface, a removable memory (for example, a flash memory or other removable memory engine) and memory slot, a PCMCIA slot and card, and other fixed or removable storage units 1122 and interfaces 1120 that allow software and data to be transferred from the storage unit 1122 to logical circuit 1100.

Logical circuit 2100 might also include a communications interface 1124. Communications interface 1124 might be used to allow software and data to be transferred between logical circuit 1100 and external devices. Examples of communications interface 1124 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1124 might typically be carried on signals, which can be electronic, electromagnetic (which includes optical) or other signals capable of being exchanged by a given communications interface 1124. These signals might be provided to communications interface 1124 via a channel 1128. This channel 1128 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1108, storage unit 1120, media 1114, and channel 1128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the logical circuit 1100 to perform features or functions of the disclosed technology as discussed herein.

Although FIG. 11 depicts a computer network, it is understood that the disclosure is not limited to operation with a computer network, but rather, the disclosure may be practiced in any suitable electronic device. Accordingly, the computer network depicted in FIG. 11 is for illustrative purposes only and thus is not meant to limit the disclosure in any respect.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for mitigating variability in standardized examination administration, the method comprising:
obtaining, from a database, a first set of testing conditions associated with a first set of standardized examinations;
obtaining, with a user interface, a first set of indications that testing conditions from the first set of testing conditions are irregular;
training an irregularity determination model based on the first set of indications and corresponding testing conditions;
obtaining a second set of testing conditions associated with a second set of standardized examinations;
applying the irregularity determination model to the second set of testing conditions to predict whether any testing condition of the second set of testing conditions is an irregular testing condition; and
reporting the irregular testing condition to the user interface.

2. The method of claim 1, further comprising refining the irregularity determination model by verifying, with the user interface, that the irregular testing condition is irregular and modifying the irregularity determination model if the irregular testing condition is not accurately flagged as irregular.

3. The method of claim 2, further comprising refining the irregularity determination model by:
calculating a specificity value as a percentage of irregular testing conditions not accurately flagged as irregular as compared with a total number of irregular testing conditions flagged by the irregularity determination model; and
adjusting model parameters for the irregularity determination model if the specificity value falls below a specificity threshold value.

4. The method of claim 2, further comprising refining the irregularity determination model by:
calculating a sensitivity value as a percentage of irregular testing conditions flagged as irregular as compared with a total number of irregular testing conditions as verified by the user interface; and
adjusting model parameters for the irregularity determination model if the sensitivity value falls below a specificity threshold value.

5. The method of claim 1, wherein the irregularity determination model comprises a machine learning model.

6. The method of claim 5, wherein the machine learning model comprises a multinomial naïve Bayes model, a logistic regression model, a convolutional neural network model, or a decision tree model.

7. The method of claim 6, further comprising refining the irregularity determination model by:
identifying true positive predictions, true negative predictions, false positive predictions, and false negative predictions from the irregularity determination model;
calculating a confusion matrix from the true positive predictions, the true negative predictions, the false positive predictions, and the false negative predictions; and
adjusting model parameters based on the confusion matrix.

8. The method of claim 1, further comprising identifying, with the user interface, disruptive testing conditions that cause disruptions to the administration of the standardized examination and correlating the disruptive testing conditions with irregular testing conditions.

9. The method of claim 1, wherein the testing conditions comprise external events, temperature parameters, humidity parameters, seating characteristics, or behavioral characteristics.

10. A system for removing variability during a standardized examination process, the computer program product comprising:
a user interface;
a database; and
an analytics logical circuit communicatively coupled to the user interface, the analytics logical circuit comprising a processor and a non-transitory memory with computer executable instructions embedded thereon, the computer executable instructions configured to cause the processor to:
obtain, from the database, a first set of testing conditions associated with a first set of standardized examinations;
obtain, from the user interface, a first set of indications that testing conditions from the first set of testing conditions are irregular;
train an irregularity determination model based on the first set of indications and corresponding testing conditions;
obtain a second set of testing conditions associated with a second set of standardized examinations;
apply the irregularity determination model to the second set of testing conditions to predict whether any testing condition of the second set of testing conditions is an irregular testing condition; and
cause the user interface to display the irregular testing condition.

11. The system of claim 10, wherein the computer executable instructions are further configured to cause the processor to refine the irregularity determination model by verifying, with the user interface, that the irregular testing condition is irregular and modify the irregularity determination model if the irregular testing condition is not accurately flagged as irregular.

12. The system of claim 11, wherein the computer executable instructions are further configured to cause the processor to:
calculate a specificity value as a percentage of irregular testing conditions not accurately flagged as irregular as compared with a total number of irregular testing conditions flagged by the irregularity determination model; and
adjust model parameters for the irregularity determination model if the specificity value falls below a specificity threshold value.

13. The system of claim 11, wherein the computer executable instructions are further configured to cause the processor to:
calculate a sensitivity value as a percentage of irregular testing conditions flagged as irregular as compared with a total number of irregular testing conditions as verified by the user interface; and
adjust model parameters for the irregularity determination model if the sensitivity value falls below a specificity threshold value.

14. The system of claim 10, wherein the irregularity determination model comprises a machine learning model.

15. The system of claim 14, wherein the machine learning model comprises a multinomial naïve Bayes model, a logistic regression model, a convolutional neural network model, or a decision tree model.

16. The system of claim 15, wherein the computer executable instructions are further configured to cause the processor to:
identify true positive predictions, true negative predictions, false positive predictions, and false negative predictions from the irregularity determination model;
calculate a confusion matrix from the true positive predictions, the true negative predictions, the false positive predictions, and the false negative predictions; and
adjust model parameters based on the confusion matrix.

17. The system of claim 10, wherein the computer executable instructions are further configured to cause the processor to identify, with the user interface, disruptive testing conditions that cause disruptions to the administration of the standardized examination and correlate the disruptive testing conditions with irregular testing conditions.

18. The system of claim 10, wherein the testing conditions comprise external events, temperature parameters, humidity parameters, seating characteristics, or behavioral characteristics.

19. A method for mitigating variability in standardized examination administration, the method comprising:
obtaining, from a database, a first set of testing conditions associated with a first set of standardized examinations;
obtaining, with a user interface, a first set of indications that testing conditions from the first set of testing conditions are irregular;
training an irregularity determination model based on the first set of indications and corresponding testing conditions;
obtaining a second set of testing conditions associated with a second set of standardized examinations;
applying the irregularity determination model to the second set of testing conditions to predict whether any testing condition of the second set of testing conditions is an irregular testing condition;
identifying, with the user interface, true positive predictions, true negative predictions, false positive predictions, and false negative predictions from the irregularity determination model;
calculating a confusion matrix from the true positive predictions, the true negative predictions, the false positive predictions, and the false negative predictions; and
adjusting model parameters based on the confusion matrix;
identifying, with the user interface, disruptive testing conditions that cause disruptions to the administration of the standardized examination and correlating the disruptive testing conditions with irregular testing conditions; and
displaying irregular testing conditions and disruptive testing conditions on the user interface.

20. The method of claim 19, wherein the testing conditions comprise external events, temperature parameters, humidity parameters, seating characteristics, or behavioral characteristics.
